(19) United States
(12) Patent Application Publication
(10) Pub. No.: US 2006/0220322 A1
(43) Pub. Date: Oct. 5, 2006

(54) Replenishment pockets on piston rings for the prevention of microwelding

(75) Inventors: Harold McCormick, Ballwin, MO (US); Shawn O'Connell, Irvine, CA (US)

Correspondence Address: STETINA BRUNDA GARRED & BRUCKER, 75 ENTERPRISE, SUITE 250, ALISO VIEJO, CA, 92656, US

(73) Assignee: JE Pistons, Inc.

(21) Appl. No.: 11/098,364

(22) Filed: Apr. 4, 2005

(51) Int. Cl. F16J 9/26

(52) U.S. Cl. 277/442

(57) ABSTRACT

A method is provided for replenishing lubricant to a piston ring groove to prevent microwelding between a piston and a piston ring from an engine. The method includes forming a plurality replenishment pockets on at least one surface of the ring; and disposing a lubricant (such as a dry-film) on the at least one side of the ring so that the plurality of replenishment pockets are substantially filled with lubricant and such that a layer of lubricant is applied to the at least one surface of the ring. During operation of the engine, the lubricant disposed in the plurality of replenishment pockets migrates onto the at least one surface of the ring and is deposited thereto to inhibit microwelding between the at least one surface of the ring and at least one of the upper and lower groove surfaces of the respective piston ring groove. The lubricant is preferred to be a dry-film lubricant.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Field of the Invention

The present invention relates to piston rings and methods to prevent microwelding between the pistons and rings. In particular, the present invention relates to a method for preventing microwelding by providing replenishment pockets on the ring surfaces and disposing lubricant (e.g., dry-film composition) within the pockets which replenishes the lubricant to the surfaces of the ring.

2. Background of the Invention

Piston rings perform a number of important functions. They seal the gap between the piston and cylinder wall to prevent combustion gases from blowing by into the crankcase. Rings stabilize the piston as it travels up and down in the bore. They help cool the piston by transferring heat into the engine block. And rings are also used to scrape oil off the cylinder walls.

The two main types of piston rings for combustion engines are compression rings and oil control rings. Typical compression ring designs are rectangular, taper faced or keystone types. Typical springless oil control ring designs are napier or taper faced napier types. Typical spring loaded oil control rings are coil spring loaded 2-piece designs or expander spring backed 3-piece designs. Each use of piston rings requires the choice of appropriate ring type, basic material, coatings or surface treatments and often the application of special additional features.

Traditionally, engine builders have designed ring sets as rigid as possible to force the rings into contact with the cylinder walls. Today, the trend in current production and racing engines is towards a more flexible ring package that better conforms to the cylinder wall. For instance, in the muscle car era, most production engines used a 5/64- 5/64- 3/16-inch package, and a 1/16- 1/16/- 3/16-inch package may have been utilized for high performance applications such as racing.

In today's ultra-competitive racing environment, every component in an engine is expected to play its part in increasing power output. Gains can come from some unlikely sources, including the piston ring. Engine builders have long sought to increase power by reducing friction, thus enabling an engine to accelerate faster. Currently, automakers and many race engine builders are utilizing thinner “metric” rings, measuring 0.43 inch, 0.43 inch, 3 mm (as a stack). And, the standard-tension oil rings have been replaced by low tension rings.

Just as high-end pistons are now machined to close tolerances, many engine builders now custom prepare piston rings to higher tolerances to reap the full benefits of new high-tech pistons. Besides decreasing friction, this approach makes for a more stable package-assuming the piston rings, piston profile, and cylinder wall finish take advantage of these improvements. In particular, top ring land flatness becomes more critical and bore finish must be absolutely correct. For example, precision ring grooves allow a reduced back clearance if ring thickness tolerances are likewise more tightly controlled.

A particular disadvantage of the thinner ring is that it has less area to transfer heat and tends to run at a higher temperature. If the clearances are too tight, temperatures in between the ring and piston rise. Therefore, smaller rings usually will not have the longevity of a larger ring due to the reduction in contact area and increased operating temperature. With higher temperatures, microwelding and scuffing of the cylinder wall may occur. Microwelding is a destructive situation where under extreme pressure the rings momentarily attach themselves to high spots on the ring groove. Or in other words, aluminum from the piston groove adheres to side surface of the ring. Ring groove smoothness is likewise extremely important; any waviness or roughness causes poor ring seal and can lead to the aforementioned microwelding to high spots on the ring groove.

There have been a variety of techniques implemented to prevent or to inhibit (at least for the duration of a race) micro-welding. One is to manufacture the pistons from exotic alloys which are more resistant to heat, but this approach is prohibitively expensive and is typically outlawed by most racing sanctioning bodies (except perhaps Formula One). Anodizing has become a popular method of improving the durability of the top ring groove because the process reduces microwelding between the ring and piston to significantly improve durability. Anodizing is done by treating the ring groove with conventional chemical applications such as sulfuric acid. The acid reacts reacts with the metal to form a tough layer of aluminum oxide which is very hard and wear resistant. However, anodizing still is prone to failure under extreme heat.

Another technique used to reduce microwelding is to improve the ring. One area of advancement in ring design is the application of low friction coatings or films to the surfaces of the ring. Piston rings are manufactured with different coatings or surface treatments to prevent excessive wear on ring periphery; scuffing on the surface of both ring and cylinder; and microwelding between ring side face and piston groove. Most rings today are made from iron. The ring face may have a channel or groove cut into it with a sprayed-in moly (molybdenum disulfide) filler. Plasma-sprayed moly over a ductile-iron base material is the preferred choice, but steel is becoming more popular because it's at least as strong and easier to machine. This combination is very forgiving and works well on most cylinder bore surfaces. Steel rings with Physical Vapor Deposition (PVD), Titanium Nitride (TiN), GDC (chromium-diamond coating), HVOF (High-Velocity-Oxygene=Fuel), and treatments such as CKS36 and CKS38 (chromium-ceramics coatings), or ceramic coatings are being used successfully in various forms of motorsports. Phosphate which has very good adhesion on nitrided steel rings is also a simple solution to reducing minor micro-welding. Chrome-plated rings have been found to prevent scuffing problems, but not microwelding.

Another solution is to apply dry solid films such as molybdenum disulfide to the upper and lower surfaces of the ring. For instance, most high-performance and racing engines now use moly-faced rings in the top groove. Although this is an effective approach, it still has some drawbacks. In particular, the dry film tends to wear off from the ring surface due to friction created from the interface fitment within the groove. Once the dry-film has been worn off, the ring and piston then become subject to possible microwelding effects.

Since dry solid films are currently a viable approach to the prevention of microwelding, it would be beneficial to further refine such techniques. In particular, it would be beneficial to provide a method and/or ring design which would replenish the dry film lubricant to the flat surfaces of the piston ring during the rings operative lifespan. If a method for replenishing dry-film lubricant to the flat surfaces of the ring could be developed, the dry-film coated rings would have a longer life span since the onset of microwelding can be further stalled or delayed in race engines and/or any other engine application.

### BRIEF SUMMARY OF THE INVENTION

The present invention is intended to overcome and solve the aforementioned problems commonly encountered with microwelding. Furthermore, the present invention provides better performance characteristics than any previously known or published approaches.

According to the present invention, a method is provided for replenishing lubricant to a piston ring groove having an upper groove surface and lower groove surface to prevent microwelding between a piston and at least one respective piston ring of an engine. The method includes forming a plurality replenishment pockets on at least one surface of the ring; and disposing a lubricant on the at least one side of the ring, such that the plurality of replenish pockets are substantially filled with dry-film lubricant and such that a layer of dry-film lubricant is applied to the at least one surface of the ring; wherein during operation of the engine, the lubricant disposed in the plurality of replenishment pockets migrates onto the at least one surface of the ring to inhibit microwelding between the at least one surface of the ring and at least one of the upper and lower groove surfaces of the respective piston ring groove. According to another aspect of the present invention, the lubricant is a dry-film lubricant.

According to an aspect of the present invention, the method further comprises forming the plurality of replenishment pockets only on an upper surface of the ring; forming the plurality of replenishment pockets only on a bottom surface of the ring; or forming the plurality of pockets on the upper and bottom surfaces of the ring.

According to another aspect of the present invention, the plurality of replenishment pockets are formed by at least one conventional milling processes, laser cutting and/or metal removal, and etching. According to yet another aspect of the present invention, the migration of lubricant from the plurality of replenishment pockets onto the at least one surface of the ring reduces friction and temperature between the at least one side of the ring and at least one of the upper and lower groove surfaces of the respective piston ring groove.

According to yet other aspects of the present invention, the plurality of replenishment pockets formed on the at least one surface of the ring are slot-shaped. For instance, the slot-shaped pockets may be radially oriented across a width of the ring and spaced apart in generally equal intervals. Or in another embodiment, the plurality of replenishment pockets formed on the at least one surface are circular-shaped. In another embodiment of the present invention, the circular-shaped replenishment pockets are uniformly spaced about a centerline of the ring. Furthermore, the plurality of circular-shaped replenishment pockets may be radially arranged in pairs and spaced apart in generally equal intervals; or, wherein the plurality of circular-shaped replenishment pockets are arranged in sets of pockets which are oriented in a stepped or staggered manner.

According to yet another embodiment of the present invention, a piston ring is provided which is adapted to inhibit microwelding to a respective piston. The ring comprises a circular piston ring adapted to be installed into a ring groove of a piston, the piston ring having an upper and lower surface, an outside ring face, and an inner side; and a plurality of replenishment pockets formed on at least one of the upper and lower surfaces of the ring. The plurality of replenishment pockets may formed only on the upper surface of the ring; the plurality of replenishments pockets may be formed only on the bottom surface of the ring; or the plurality of replenishment pockets may be formed both on the upper and lower surfaces of the ring.

Additionally, another aspect of the present invention is that the plurality of replenishment pockets are formed by a laser. According to yet another aspect of the present invention, lubricant is disposed into the plurality of replenish pockets, and may be further disposed onto at least one of the upper and lower surfaces of the ring. In yet another aspect of the present invention, the lubricant is a dry-film lubricant which is adapted to migrate from the plurality of replenishment pockets onto at least one of the upper and lower surfaces of the ring.

And other aspects of the present invention includes slot-shaped replenishment pockets, wherein the slot-shaped pockets are radially oriented across a width of the ring and spaced apart in generally equal intervals. In another embodiment of the present invention, the plurality of replenishment pockets formed are circular-shaped. In this embodiment, the plurality of circular-shaped replenishment pockets may be radially arranged in pairs and spaced apart in generally equal intervals; or the plurality of circular-shaped replenishment pockets are arranged in sets of pockets which are oriented in a stepped or staggered a manner.

In another aspect of the present invention, the plurality of replenishment pockets cover a range between about 30 percent to about 10 percent of at least one of the upper and lower surface of the ring, and more preferably about 20 percent of at least one of the upper and lower surface of the ring. Another aspect of the present invention includes forming the replenishment pocket to about 0.001 thousandths of an inch in depth.

Other exemplary embodiments and advantages of the present invention may be ascertained by reviewing the present disclosure and the accompanying drawings.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 is depicts a conventional prior art piston;

FIG. 2 is a cross-sectional view of the ring grooves taken from Detail 2 of FIG. 1;

FIG. 3 is a first exemplary embodiment of a ring having slot-shaped replenish pockets disposed on the upper surface of the ring, according to an aspect of the present invention;

FIG. 4 shows an exemplary arrangement of the slot-shaped replenish pockets on the upper surface of the ring is a detail view taken from Detail 4 of FIG. 3, according to an aspect of the present invention;

FIG. 5 shows a close-up view of an exemplary slot-shaped replenish pocket taken Detail 5 of FIG. 4, according to an aspect of the present invention;

FIG. 6 shows a cross-section of the ring taken along Cross-section 6-6 of FIG. 4, according to an aspect of the present invention;

FIG. 7 is a second exemplary embodiment of a ring having a plurality radial-spaced pairs of circular-shaped replenish pockets disposed on the upper surface of the ring, according to an aspect of the present invention;

FIG. 8 shows an exemplary arrangement of the plurality of radial-spaced pairs of circular-shaped replenish pockets taken from Detail 8 of FIG. 7, according to an aspect of the present invention;

FIG. 9 shows a cross-section of the ring taken along Cross-section 9-9 of FIG. 8, according to an aspect of the present invention;

FIG. 10 is a third exemplary embodiment of a ring having a plurality of sets of stepped or staggered circular-shaped replenish pockets disposed on the upper surface of the ring, according to an aspect of the present invention;

FIG. 11 shows an exemplary arrangement of the stepped or staggered circular-shaped replenish pockets disposed on the upper surface of the ring taken from Detail 11 of FIG. 10, according to an aspect of the present invention;

FIG. 12 shows a cross-section of the ring taken along Cross-section 12-12 of FIG. 11, according to an aspect of the present invention;

FIG. 13 is a fourth exemplary embodiment of a ring having a plurality of circular-shaped replenish pockets uniformly disposed on the upper surface of the ring, according to an aspect of the present invention;

FIG. 14 shows an exemplary arrangement of the plurality of circular-shaped replenish pockets uniformly disposed on the upper surface of the ring taken from Detail 15 of FIG. 13, according to an aspect of the present invention; and

FIG. 15 shows a cross-section of the ring taken along Cross-section 15-15 of FIG. 14, according to an aspect of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Description of a Conventional Piston

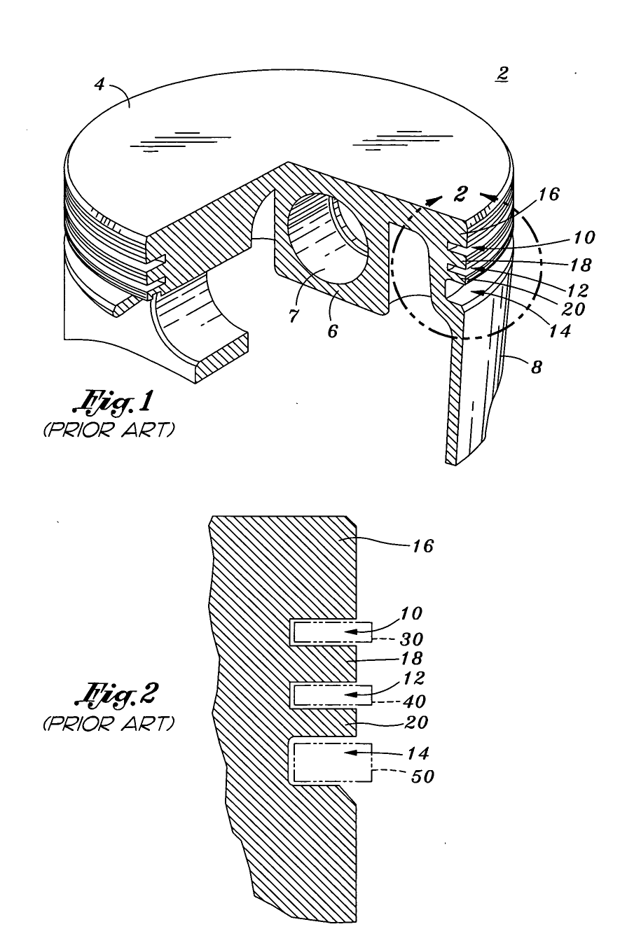

FIG. 1 depicts a conventional prior art piston 2 for an internal combustion engine. The piston has a cylindrical shape with a head 4 (or top) and is generally hollow inside. The lower end of the cylindrical wall of the piston 2 is known as the skirt 8. Internally disposed within the piston 4 is a pair of pin bosses 6 which each have a pin bore 7 adapted to receive a wrist pin (not shown) in which a connecting rod (not shown) is rotatably attached. Formed within the outer cylindrical wall of the piston 2 proximate the head 4 are three ring grooves, including a first (or top) ring groove 10, a second ring groove 12, and an oil ring groove 14.

FIG. 2 is detail view of the ring grooves from FIG. 1 taken along cross-section 2-2. The head 4 of the piston 2 also forms the top land 16 which provides the top surface of the top ring groove 10. A second land is disposed between the top ring groove 10 and the second ring groove 12, thereby providing the lower surface of the top ring groove 10 and the upper surface of the second ring groove 12. A third land is disposed between the second ring groove 12 and the oil ring groove 14, thereby providing the lower surface of the second ring groove 20 and the upper surface of the oil ring groove 14. Also shown in phantom lines are the top ring 30, the second ring 40, and the third ring 50.

Rings with Replenishment Pockets

The present invention, various aspects thereof, and various embodiments thereof are shown in FIGS. 3-15. To overcome the unwanted dissipation of coatings and dry-films from the flat surfaces of the ring due to friction and high temperatures, one aspect of the present invention is the incorporation of replenishment pockets 32, 42, 52 or 62 on the flat surfaces of the ring 30, 40, 50 or 60 (i.e., the upper 24 and lower 26 surfaces). Such pockets may vary in size, depth, the number used, and the arrangement or orientation in which the pockets are formed in the upper and lower flat surface of the ring.

The pockets 32, 42, 52 or 62 may be formed by a various known metal removal techniques, for example mechanical removal by milling tools, laser removal, or by chemical etching. A depth of 0.001 thousandths of an inch is an exemplary preferred depth; however, it is appreciated that the depth of the pocket may vary according to each application. For instance, if it desired that the replenishment pockets store more lubricant, than the depth can be increased in any desired increment. Thus, it is foreseeable that a depth ranging from about 0.001 thousandths to 0.010 thousandths (or even larger) may be implemented depending on the overall thickness of the ring, so long as the overall strength of the ring is not greatly effected.

It is preferred that the number and shape (i.e., total area covered) of the replenishment pockets 32, 42, 52 or 62 be correlated to a percentage of total coverage of the surface of the ring 30, 40, 50 or 60. For instance, it is preferred that a range between about 30 percent to about 10 percent of the ring surface be covered by replenishment pockets. And it is even more preferable that the replenishment pockets cover about 20 percent of the ring surface. Thus, it can be seen, that the size of the replenishment pockets (i.e., the diameter size or shape) and the number of replenishment pockets disposed on the ring surface, and depths thereof, can be adjusted and/or vary to meet a specific total replenishment pocket coverage requirement. Hence, it is foreseeable that pocket size and volume can be correlated directly to a desired life period for the rings.

The lubricant disposed within the replenishment pockets may comprise a variety of materials and/or compositions, for example, various dry-film lubricants or any other composition which may be disposed within a replenishment pocket. The lubricant may be for example, graphite tungsten disulfide or molybdenum disulfide. It is noted, however, that the aforementioned list of lubricants is merely exemplary and is not intended to be comprehensive. Rather, it is well-known that from time to time, preferred dry film compositions or lubricants which may be ideally adapted to be disposed within the replenishment pockets may be invented or developed, and that such advancements in compositions or lubricants may also be utilized in the replenishment pockets in the foreseeable future.

The manner in which the replenishment pockets function is now explained. As already discussed, the replenishment pockets 32, 42, 52 or 62 act as reservoirs which contain lubricant, such as a dry-film or a coating. Furthermore, at least one of the upper 24 and lower 26 surfaces of the ring may be further coated with lubricant or a coating. As the pistons move up and down, the upper and lower ring surface may typically contact portions of the grooves 10, 12, 14 and lands 16, 18, 20 formed in the piston 2. Moreover, the rings may slightly rotate within the groves 10, 12, 14. Such surface to surface contact (i.e. friction) under extreme heat tends to remove and dissipate the lubricant from the top and bottom surfaces of the ring. When the lubricant, such as dry film has been worn from the top and bottom surfaces of the ring, the dry-film from the replenishment pockets is displaced and migrates from the pockets (from friction) and is redeposited onto the flat surfaces of the ring.

Following are several examples of ring designs which utilize the exemplary replenishment pockets.

Slot-Shaped Replenishment Pockets

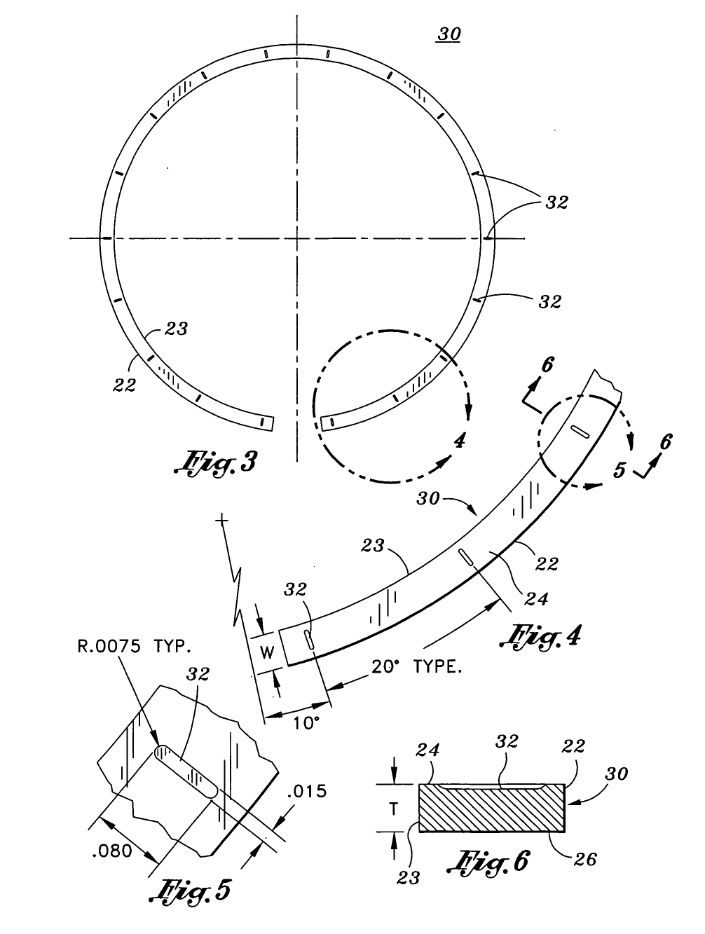

FIG. 3 is a first exemplary embodiment of a ring 30 having slot-shaped replenishment pockets 32 disposed on at least one of the flat surfaces of the ring, according to an aspect of the present invention. The ring 30 is defined by an inner side 23, and outer ring face side 23, and substantially flat top and bottom surfaces 24, 26. The ring 30 further is defined by a width W (see FIG. 4) and a thickness T (see FIG. 6).

FIG. 4 is a detail view taken from Detail 4 of FIG. 3 which shows an exemplary arrangement of the slot-shaped replenish pockets 32 on at least one of the surfaces of the ring 24, 26, according to an aspect of the present invention. In this embodiment, a plurality of slot-shaped pockets 32 are radially aligned (i.e., spanning the width W of the ring) and equally spaced around the ring 30. In the particular example, there are eighteen pockets 32 disposed on the top surface 24 of the ring 30, wherein each pocket 32 is spaced apart by about 20 degrees, and wherein the pockets 32 start at about 10 degrees from the end gap of the ring 30. It is noted that the slot-shaped pockets 32 may be arranged and/or oriented in many different ways, and therefore, the present invention should not be limited merely to the first exemplary embodiment depicted in FIGS. 3-6. For example, the slot-shaped pockets 32 need not be radially aligned; as an alternative, the slot-shaped pockets 32 may be slanted at angles, or the spacing may also vary depending on the number of pockets desired to be formed on the surfaces 24, 26 of the ring 30.

FIG. 5 is a detail view taken from Detail 5 of FIG. 4 which shows a close-up view of an exemplary slot-shaped replenishment pocket 32, according to an aspect of the present invention. This exemplary embodiment of a slot-shaped pocket 32 has the dimensions of 0.080 inches in length, about 0.15 inches in width, and a radius of about 0.0075 inches. However, it is noted that the shape and dimensions of the slot-shaped pocket 32 may vary, and thus the present invention should not be limited to merely to the first exemplary embodiment shown in the FIGS. 3-6

FIG. 6 is a detail view taken from FIG. 4 which shows a cross-section of the ring 30 taken along Cross-section 6-6, according to an aspect of the present invention. As discussed, the slot-shaped pockets 32 may be formed either on the top surface 24 (as shown in FIG. 6), the pockets 32 may be formed on the bottom surface 26 (not shown in FIG. 6), or the pockets 32 may be formed on both flat sides of the ring 30.

Radial-Spaced Pairs of Circular-Shaped Replenishment Pockets

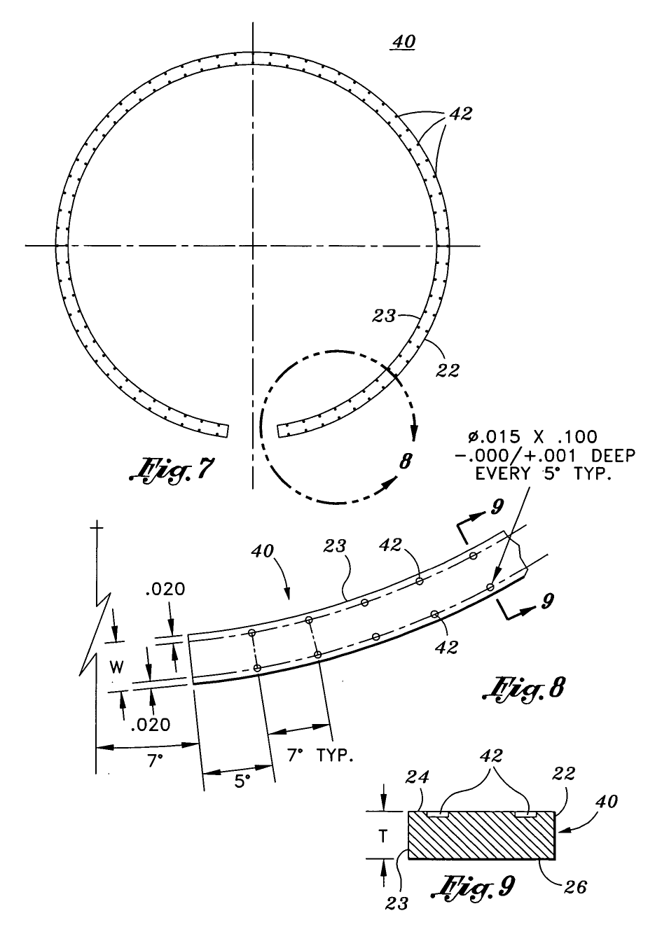

FIG. 7 is a second exemplary embodiment of a ring 40 having a plurality of radial-spaced pairs of circular-shaped replenishment pockets 42 disposed on at least one of the flat surfaces of the ring 40, according to an aspect of the present invention. The ring 40 is defined by an inner side 23, an outer ring face side 22, and substantially flat top and bottom surfaces 24, 26. The ring 40 further is defined by a width W (see FIG. 8) and a thickness T (see FIG. 9).

FIG. 8 is a detail view taken from Detail 8 of FIG. 7 which shows an exemplary arrangement of the circular-shaped pairs replenishment pockets 42 on at least one of the surfaces of the ring 24, 26, according to an aspect of the present invention. In this exemplary embodiment, a plurality of circular-shaped pairs pockets 42 are radially aligned (i.e., spanning the width W of the ring), circumferentially aligned, and equally spaced around the ring 40. In the particular example, there are a plurality of pairs of pockets 42 disposed on the top surface 24 of the ring 40, wherein each pair of pockets 42 is spaced apart by about 5 degrees, and wherein the pockets 42 start at about 12 degrees from the end gap of the ring 40. Furthermore, each circular-shaped pocket 42 is spaced about 0.020 inches from the ring face 22 or the inner side 23. The exemplary embodiment of a circular-shaped pocket 42 has the dimensions of 0.015 inches in diameter; however, it is appreciated that the size of the pocket 42 may vary according to the application.

It is noted that the circular-shaped pockets 42 may be arranged and/or oriented in many different ways, and therefore, the present invention should not be limited merely to the exemplary embodiment depicted in FIGS. 7 through 9. For example, the circular-shaped pair of pockets 42 need not be radially aligned; as an alternative, the circular-shaped pair of pockets 42 may be slanted at angles, or the spacing may also vary depending on the number of pair pockets desired to be formed on the surfaces 24, 26 of the ring 40. Moreover, the overall diameter, depth and/or shape of the circular-shaped pockets 42 may vary, and thus the present invention should not be limited to merely to the second exemplary embodiment shown in FIGS. 7-9.

FIG. 9 is a detail view taken from FIG. 8 which shows a cross-section of the ring 40 taken along Cross-section 9-9, according to an aspect of the present invention. As discussed, the circular-shaped pockets 42 may be formed either on the top surface 24 (as shown in FIG. 9), the pockets 42 may be formed on the bottom surface 26 (not shown in FIG. 9), or the pockets 42 may be formed on both flat sides of the ring 40. Furthermore, the depth of the pocket 42 may vary depending on the amount of lubricant that is desired to be disposed within the pockets 42.

Stepped or Staggered Circular-Shaped Replenishment Pockets

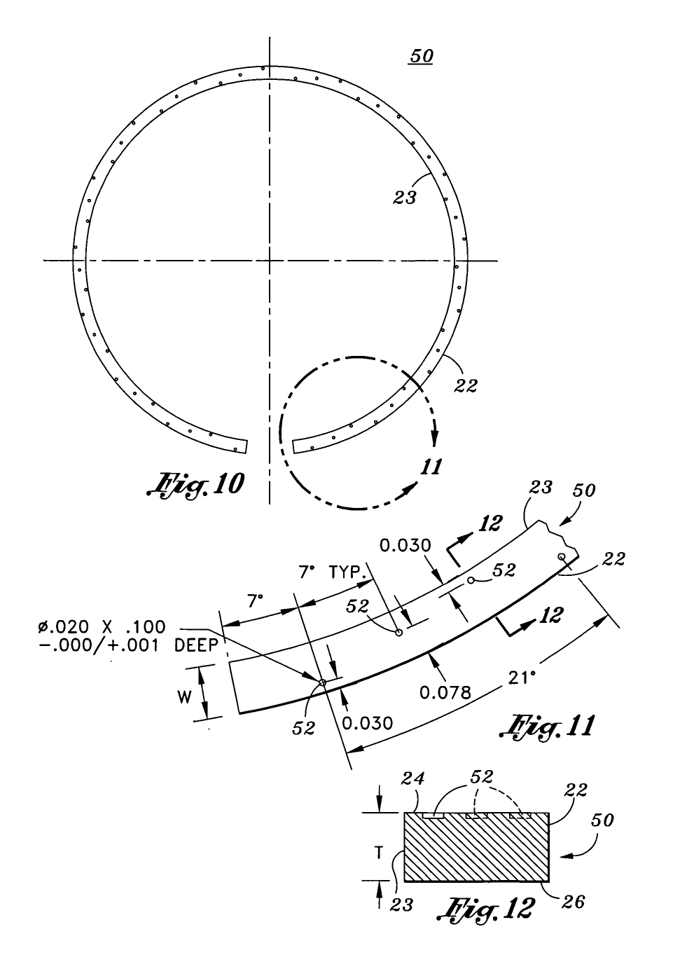

FIG. 10 is a third exemplary embodiment of a ring 50 having a plurality of sets of stepped or staggered circular-shaped replenishment pockets 52 disposed on at least one of the flat surfaces of the ring 50, according to an aspect of the present invention. The ring 50 is defined by an inner side 23, and outer ring face side 22, and substantially flat top and bottom surfaces 24, 26. The ring 50 further is defined by a width W (see FIG. 11) and a thickness T (see FIG. 12).

FIG. 11 is a detail view taken from Detail 11 of FIG. 10 which shows an exemplary arrangement of the plurality of sets of stepped or staggered circular-shaped replenishment pockets 52 on at least one of the surfaces of the ring 24, 26, according to an aspect of the present invention. In this exemplary embodiment, a plurality of circular-shaped pockets 52 are arranged in stepped or staggered sets, which have the appearance of a zig-zagging pattern. In particular, there are a plurality of pockets 52 disposed on the top surface 24 of the ring 50, wherein each pockets 52 is spaced apart by about 7 degrees, and wherein the pockets 52 start at about 7 degrees from the end of the ring 50. The three pocket pattern is then repeated every 21 degrees around the circumference of the ring 50. The pockets 52 closest to the ring face 22 and inner side 23 are spaced from the ring face 22 and inner side 23 by about 0.030 inches. The exemplary embodiment of a circular-shaped pocket 52 has the dimensions of 0.020 inches in diameter; however, it is appreciated that the size of the pocket 42 may vary according to the application.

It is noted that the circular-shaped pockets 52 may be arranged and/or oriented in many different ways, and therefore, the present invention should not be limited merely to the second exemplary embodiment depicted in the Figures. For example, the circular-shaped pockets 52 need not be in a three pocket pattern; as an alternative, the circular-shaped pockets 52 may be in a two pocket zig-zagging pattern, or the spacing may also vary depending on the number of pockets 52 desired to be formed on the surfaces 24, 26 of the ring 50. Moreover, the overall diameter, depth and/or shape of the circular-shaped pockets 52 may vary, and thus the present invention should not be limited to merely to the second exemplary embodiment shown in FIGS. 10-12.

FIG. 12 is a detail view taken from FIG. 8 which shows a cross-section of the ring 40 taken along Cross-section 12-12, according to an aspect of the present invention. As discussed, the circular-shaped pockets 52 may be formed either on the top surface 24 (as shown in FIG. 12), the pockets 52 may be formed on the bottom surface 26 (not shown in FIG. 12), or the pockets 52 may be formed on both flat sides of the ring 50. Furthermore, the depth of the pocket 52 may vary depending on the amount of lubricant that is desired to be disposed within the pockets 52.

Evenly Spaced Circular-Shaped Replenishment Pockets

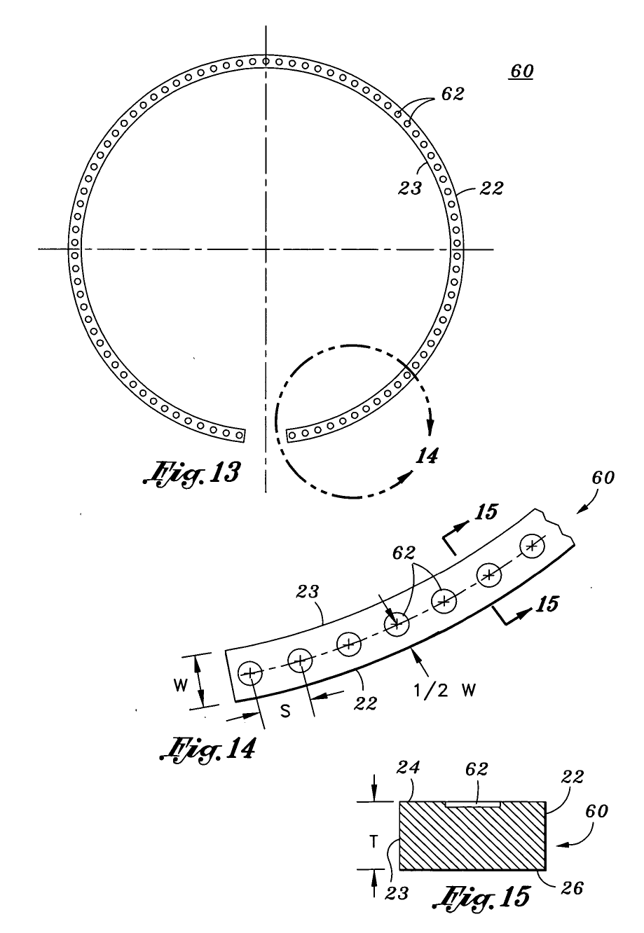

FIG. 13 is a fourth exemplary embodiment of a ring 60 having a plurality circular-shaped replenishment pockets 62 uniformly spaced about a centerline of one of at least the upper and lower surfaces of the ring 60, according to an aspect of the present invention. The ring 60 is defined by an inner side 23, and outer ring face side 22, and substantially flat upper and lower surfaces 24, 26. The ring 60 further is defined by a width W (see FIG. 11) and a thickness T (see FIG. 12).

FIG. 14 is a detail view taken from Detail 14 of FIG. 13 which shows an exemplary arrangement of the plurality circular-shaped replenishment pockets 62, each of which have the same diameter, and of which are also uniformly spaced on at least one of the surfaces of the ring 24, 26, according to an aspect of the present invention. In this exemplary embodiment, it is preferred that the number and diameter (D) of the pockets 62 be correlated to a percentage of total coverage of the surface of the ring 60. For instance, it is preferred that about a range between about 30 percent to 10 percent of the ring surfaces 24, be covered by replenish pockets 62. And it is even more preferred that the replenish pockets 62 cover about 20 percent of the ring surface 24. Thus, it can be seen, that the size of the replenish pockets 62 (i.e., the diameter D) and the number of replenish pockets 62 disposed on the ring surfaces 24, 26 (i.e., the spacing S), and depths thereof, can be adjusted/vary to meet a specific total replenishment pocket coverage requirement.

It is further noted that the circular-shaped pockets 62 may be arranged and/or oriented in many different ways, and therefore, the present invention should not be limited merely to the fourth exemplary embodiment depicted in FIGS. 13-15. For example, the circular-shaped pockets 62 need not be uniformly disposed and evenly spaced on the surface 24 (and/or surface 26) of the ring 60; as an alternative, the circular-shaped pockets 62 may be in a zig-zagging pattern. Moreover, the overall diameter, depth and/or shape of the circular-shaped pockets 62 may vary, and thus, the present invention should not be limited to merely to the fourth exemplary embodiment shown in FIGS. 13-15.

FIG. 15 is a detail view taken from FIG. 14 which shows a cross-section of the ring 40 taken along Cross-section 15-15, according to an aspect of the present invention. As discussed, the circular-shaped pockets 62 may be formed either on the top surface 24 (as shown in FIG. 15), the pockets 62 may be formed on the bottom surface 26 (not shown in FIG. 15), or the pockets 62 may be formed on both flat sides of the ring 60. Furthermore, the depth of the pocket may vary depending on the amount of lubricant that is desired to be disposed within the pockets 62.

Other Aspects of the Present Invention

It is noted that the aforementioned exemplary embodiments of the shapes and arrangement of the replenishment pockets should not be limited only to the disclosed examples. For instance, the pockets may be formed in other shapes such as squares, rectangles, ovals, small microgrooves, or any other means which may be formed in a surface of a ring and in which lubricant (e.g., dry-film) may be deposited therein. It is further noted that the pockets may be formed with various manufacturing processes besides laser, such as etching.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and such uses are within the scope of the appended claims.

1. A method for replenishing lubricant to a piston ring groove having an upper groove surface and lower groove surface to prevent microwelding between a piston and at least one respective piston ring of an engine, wherein the ring has an upper and lower surface, the method comprising:
forming a plurality of replenishment pockets on at least one of the upper and lower surface of the ring; and
disposing a lubricant on at least one of the upper and lower surface of the ring, such that the plurality of replenishment pockets are substantially filled with a lubricant and such that a layer of lubricant is applied to at least one of the upper and lower surface of the ring;
wherein during operation of the engine, the lubricant disposed in the plurality of replenishment pockets migrates onto at least one of the upper and lower surface of the ring and is deposited thereto, such that microwelding is inhibited between at least one of the upper and lower surface of the ring and at least one of the upper and lower groove surfaces of the piston ring groove.

2. The method according to claim 1, further comprising forming the plurality of replenishment pockets only on the upper surface of the ring.

3. The method according to claim 1, further comprising forming the plurality of replenishment pockets only on the bottom surface of the ring.

4. The method according to claim 1, further comprising forming the plurality of pockets on both the upper and lower surface of the ring.

5. The method according to claim 1, wherein the plurality of replenishment pockets are formed by at least one of conventional milling, laser and chemical etching.

6. The method according to claim 1, wherein the migration of lubricant from the plurality of replenishment pockets onto at least one of the upper and lower surface of the ring reduces friction and temperature between at least one of the upper and lower surface of the ring and at least one of the upper and lower groove surface of the piston ring groove.

7. The method according to claim 1, wherein the plurality replenishment pockets formed on at least one of upper and lower surface of the ring are slot-shaped.

8. The method according to claim 7, wherein the slot-shaped pockets are radially oriented across a width of the ring and spaced apart in generally equal intervals about a circumference of the ring.

9. The method according to claim 1, wherein the plurality of replenishment pockets are circular-shaped.

10. The method of according to claim 9, wherein the circular-shaped replenishment pockets are uniformly spaced about a centerline of the ring.

11. The method according to claim 9, wherein the plurality of circular-shaped replenishment pockets are radially arranged in pairs and spaced apart in generally equal intervals.

12. The method according to claim 9, wherein the plurality of circular-shaped replenishment pockets are arranged in sets of pockets which are oriented in a stepped or staggered manner.

13. The method according to claim 1, wherein the lubricant comprises a dry-film lubricant.

14. The method according to claim 13, wherein the dry-film lubricant comprises one of graphite tungsten disulfide or molybdenum disulfide.

15. The method according to claim 1, wherein the plurality of replenishment pockets cover a range between about 30 percent to about 10 percent of at least one of the upper and lower surface of the ring.

16. The method according to claim 15, wherein the plurality of replenishment pockets cover about 20 percent of at least one of upper and lower surface of the ring.

17. The method according to claim 1, wherein a depth of each replenishment pocket is about 0.001 thousandths of an inch.

18. A piston ring adapted to inhibit microwelding to a respective piston, the ring comprising:
a circular piston ring adapted to be installed into a ring groove of a piston, the piston ring having an upper and lower surface, an outside ring face, and an inner side; and
a plurality of replenishment pockets formed on at least one of the upper and lower surface of the ring.

19. The piston ring according to claim 18, wherein the plurality of replenishment pockets are formed only on the upper surface of the ring.

20. The piston ring according to claim 18, wherein the plurality of replenishments pockets are formed only on the bottom surface of the ring.

21. The piston ring according to claim 18, wherein the plurality of replenishment pockets on formed on both the upper and lower surface of the ring.

22. The piston ring according to claim 18, wherein the plurality of replenishment pockets are formed by at least one of conventional milling, laser and chemical etching.

23. The piston ring according to claim 18, further comprising lubricant disposed into the plurality of replenish pockets.

24. The piston ring according to claim 23, wherein the lubricant is a dry-film lubricant.

25. The piston ring according to claim 24, wherein the dry-film lubricant comprises one of graphite, tungsten disulfide or molybdenum disulfide.

26. The piston ring according to claim 24, wherein the dry-film is adapted to migrate from the plurality of replenishment pockets onto at least one of the upper and lower surface of the ring.

27. The piston ring according to claim 18, wherein the plurality replenishment pockets are slot-shaped.

28. The piston ring according to claim 27, wherein the slot-shaped pockets are radially oriented across a width of the ring and spaced apart in generally equal intervals.

29. The piston ring according to claim 18, wherein the plurality of replenishment pockets are circular-shaped.

30. The piston ring according to claim 29, wherein the circular-shaped replenishment pockets are uniformly spaced about a centerline of the ring.

31. The piston ring according to claim 30, wherein the plurality of circular-shaped replenishment pockets are radially arranged in pairs and spaced apart in generally equal intervals.

32. The piston ring according to claim 29, wherein the plurality of circular-shaped replenishment pockets are arranged in sets of pockets which are oriented in a stepped or staggered a manner.

33. The piston ring according to claim 18, wherein the plurality of replenishment pockets cover a range between about 30 percent to about 10 percent of at least one of the upper and lower surface of the ring.

34. The piston ring according to claim 33, wherein the replenishment pockets cover about 20 percent of at least one of the upper and lower surface of the ring.

35. The piston ring according to claim 1, wherein a depth of each replenishment pocket is about 0.001 thousandths of an inch.
